(19) United States
(12) Patent Application Publication
(10) Pub. No.: US 2022/0214558 A1
(43) Pub. Date: Jul. 7, 2022

(54) OPTICAL UNIT AND IMAGING DEVICE

(71) Applicant: SONY SEMICONDUCTOR SOLUTIONS CORPORATION, Kanagawa (JP)

(72) Inventors: Hiroyuki GOTO, Kumamoto (JP); Masashi SHIRAISHI, Kumamoto (JP); Takahiro NOZOE, Kumamoto (JP); Yoshihito NAGAWA, Kumamoto (JP)

(73) Assignee: SONY SEMICONDUCTOR SOLUTIONS CORPORATION, Kanagawa (JP)

(21) Appl. No.: 17/613,140

(22) PCT Filed: Apr. 27, 2020
(86) PCT No.: PCT/JP2020/017905

§ 371 Date: Nov. 22, 2021

(30) Foreign Application Priority Data
May 31, 2019 (JP) 2019-102252

(51) Int. Cl. G02B 27/64; G02B 7/02

(52) U.S. Cl. CPC G02B 27/646; G02B 7/02

(57) ABSTRACT

A driving speed of a lens barrel in an optical unit is improved. The optical unit includes a lens barrel, a housing, a front driving portion, and a rear driving portion. The lens barrel includes an imaging optical system. The housing includes a front supporting portion and a rear supporting portion in order to support the lens barrel, the front supporting portion being disposed at a front in a direction toward a subject along an optical axis of the imaging optical system, and the rear supporting portion being disposed at a rear with an orientation opposite to being at the front. The front driving portion connects the lens barrel and the front supporting portion and drives the lens barrel. The rear driving portion connects the lens barrel and the rear supporting portion and drives the lens barrel.

### TECHNICAL FIELD

The present disclosure relates to an optical unit and an imaging device. More specifically, the present disclosure relates to an optical unit that drives a lens barrel, and an imaging device including the optical unit.

### BACKGROUND ART

In the related art, an optical unit including a lens barrel having an optical system, such as a lens, disposed therein has been used in an imaging device such as a camera. In the optical unit, the focal position of a subject can be adjusted by adjusting the positions of the optical system and the lens barrel. Such position adjustment for the lens barrel or the like can be performed by displacing the lens barrel or the like using a driving element that expands and contracts in accordance with a voltage to be applied. An electrostrictive polymer actuator can be used as the driving element. The electrostrictive polymer actuator is a driving element configured such that a polymer elastomer is disposed between two electrodes. The electrostrictive polymer actuator expands and contracts by applying a voltage between the two electrodes to generate a Coulomb force and deform the polymer elastomer.

As such an optical unit, for example, an optical unit in which a driving element configured in a cylindrical shape is disposed on an end face of a lens barrel on an imaging surface side is used (see, for example, PTL 1). In the optical unit, the driving element supports the lens barrel and supplies a driving power source to the driving element, so that the driving element expands in an optical axis direction and drives the lens barrel in the optical axis direction. In addition, the lens barrel can also be inclined by dividing the driving element into a plurality of elements and individually applying drive power sources to the elements to drive the elements.

### CITATION LIST

### Patent Literature

### [PTL 1]

JP 2009-069588A

### SUMMARY

### Technical Problem

In the above-described related art, there is a problem in that a driving speed of the lens barrel is low. Because of a configuration in which the driving element is disposed only on the end face of the lens barrel on the imaging surface side, there is a problem in that a driving force is insufficient and a driving speed is reduced.

The present disclosure is contrived in view of the above-described problems, and an object thereof is to improve a driving speed of a lens barrel in an optical unit.

### Solution to Problem

The present disclosure is contrived in view of the above-described problems, and a first aspect thereof is an optical unit including a lens barrel that includes an imaging optical system, a housing that includes a front supporting portion and a rear supporting portion in order to support the lens barrel, the front supporting portion being disposed at a front in a direction toward a subject along an optical axis of the imaging optical system, and the rear supporting portion being disposed at a rear with an orientation opposite to being at the front, a front driving portion that connects the lens barrel and the front supporting portion and drives the lens barrel, and a rear driving portion that connects the lens barrel and the rear supporting portion and drives the lens barrel.

Further, in the first aspect, the front driving portion and the rear driving portion may be driven by displacing the lens barrel.

Further, in the first aspect, a driving element that displaces the lens barrel may be disposed in the front driving portion and the rear driving portion.

Further, in the first aspect, the driving element may be constituted by a piezoelectric element.

Further, in the first aspect, a plurality of the driving elements may be disposed in the front driving portion and the rear driving portion.

Further, in the first aspect, the rear driving portion may be configured such that a plurality of driving elements are disposed at positions facing the plurality of driving elements of the front driving portion.

Further, in the first aspect, the rear driving portion may be configured such that a plurality of driving elements are disposed at positions shifted from the plurality of driving elements of the front driving portion.

Further, in the first aspect, the front driving portion and the rear driving portion may be disposed obliquely with respect to the optical axis.

Further, in the first aspect, the lens barrel may include a driving portion connection portion to which the front driving portion and the rear driving portion are connected.

Further, in the first aspect, at least one of the front driving portion and the rear driving portion may also shield incident light.

In addition, a second aspect of the present disclosure is an imaging device including an imaging element, a lens barrel that includes an imaging optical system that forms an image of a subject on the imaging element, a housing that includes a front supporting portion and a rear supporting portion in order to support the lens barrel, the front supporting portion being disposed at a front in a direction toward a subject along an optical axis of the imaging optical system, and the rear supporting portion being disposed at a rear with an orientation opposite to being at the front, a front driving portion that connects the lens barrel and the front supporting portion and drives the lens barrel, and a rear driving portion that connects the lens barrel and the rear supporting portion and drives the lens barrel.

Adopting such aspects leads to an effect that a lens barrel is driven by a front driving portion and a rear driving portion. It is assumed that a driving force is transmitted from each of a front direction and a rear direction.

### BRIEF DESCRIPTION OF DRAWINGS

FIG. 1 is a diagram showing a configuration example of an imaging device according to an embodiment of the present disclosure.

FIG. 2 is a cross-sectional view showing a configuration example of an imaging device according to a first embodiment of the present disclosure.

FIG. 3 is a diagram showing an example of the arrangement of driving elements according to the first embodiment of the present disclosure.

FIG. 4 is a diagram showing an example of the arrangement of driving elements according to a modification example of the first embodiment of the present disclosure.

FIG. 5 is a diagram showing an example of the arrangement of driving elements according to a second embodiment of the present disclosure.

FIG. 6 is a diagram showing an example of the arrangement of driving elements according to a modification example of the second embodiment of the present disclosure.

FIG. 7 is a diagram showing another example of the arrangement of driving elements according to a modification example of the second embodiment of the present disclosure.

FIG. 8 is a cross-sectional view showing a configuration example of an imaging device according to a third embodiment of the present disclosure.

FIG. 9 is a diagram showing an example of the arrangement of driving elements according to a fourth embodiment of the present disclosure.

FIG. 10 is a diagram showing an example of the arrangement of driving elements according to a fifth embodiment of the present disclosure.

FIG. 11 is a block diagram showing a schematic configuration example of a camera which is an example of a device to which the present technique is applicable.

FIG. 12 is a diagram showing an example of a method of adjusting an optical axis according to an embodiment of the present disclosure.

### DESCRIPTION OF EMBODIMENTS

Next, embodiments for implementing the present disclosure (hereinafter, referred to as embodiments) will be described with reference to the drawings. In the following drawings, the same or similar portions are denoted by the same or similar reference numerals and signs. In addition, embodiments will be described in the following order.

### 1. First Embodiment

### 2. Second Embodiment

### 3. Third Embodiment

### 4. Fourth Embodiment

### 5. Fifth Embodiment

### 6. Sixth Embodiment

### 1. First Embodiment

### [Configuration of Imaging Device]

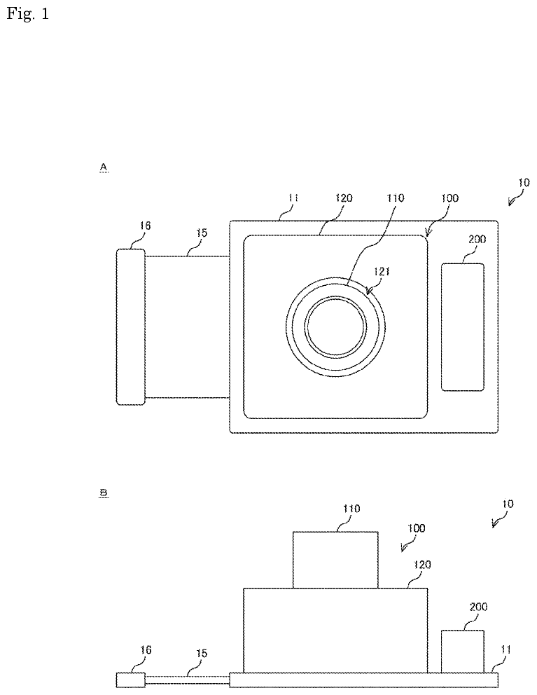

FIG. 1 is a diagram showing a configuration example of an imaging device according to an embodiment of the present disclosure. A in the drawing is a top view showing a configuration example of an imaging device 10, and B in the drawing is a side view showing a configuration example of the imaging device 10. The imaging device 10 in the drawing includes a substrate 11, an optical unit 100, a control unit 200, a signal cable 15, and a connector 16.

The substrate 11 is a substrate on which an imaging element 12 to be described later, the optical unit 100, and the control unit 200 are mounted. A wiring that transmits signals of the imaging element 12 and the like is disposed in the substrate 11.

The optical unit 100 forms an image of a subject in the imaging element 12 and protects the imaging element 12. The optical unit 100 includes a lens barrel 110 and a housing 120.

The lens barrel 110 includes an optical system such as a lens to form an image of a subject in the imaging element 12. The lens barrel 110 in the drawing shows an example of a lens barrel configured in a cylindrical shape.

The housing 120 holds the lens barrel 110 and covers the imaging element 12. An opening portion 121 is disposed at the center portion of the upper surface of the housing 120. The lens barrel 110 is disposed to pass through the opening portion 121. In addition, a driving portion that drives the lens barrel 110 is disposed in the housing 120.

The control unit 200 controls the driving portion of the housing 120. The control unit 200 performs control by outputting a driving signal to the above-described driving portion. In addition, the control unit 200 can also control the imaging element 12 and process an image signal which is generated by the imaging element 12.

The signal cable 15 transmits a signal such as an image signal. The signal cable 15 in the drawing is constituted by a plurality of signal lines and is connected to the wiring of the substrate 11. A connector 16 for connection to equipment such as a camera is disposed in the signal cable 15 in the drawing.

### [Cross-Sectional Configuration of Imaging Device]

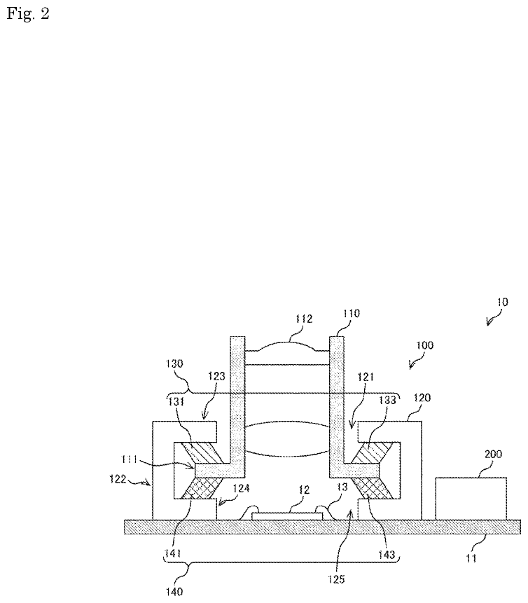

FIG. 2 is a cross-sectional view showing a configuration example of an imaging device according to a first embodiment of the present disclosure. In the drawing, the imaging device 10 includes the imaging element 12, the lens barrel 110, the housing 120, a front driving portion 130, and a rear driving portion 140. Meanwhile, in the drawing, the signal cable 15 and the connector 16 are not shown.

The imaging element 12 is a semiconductor element that generates and outputs an image signal corresponding to incident light. The imaging element 12 is constituted by a semiconductor chip and is mounted as a bare chip on the substrate 11. Specifically, the imaging element 12 is bonded to the substrate 11 and is connected to a pad (not shown) formed in the substrate 11 by a bonding wire 13. The pad is connected to the wiring of the substrate 11.

The lens barrel 110 is disposed between a subject and the imaging element 12 and forms an image of the subject on a light receiving surface of the imaging element 12. The lens barrel 110 in the drawing is configured in a cylindrical shape as described above, and shows an example in which a plurality of lenses 112 are disposed as an optical system. The position of the optical system of the lens barrel 110 is adjusted to an optical axis that passes through the center portion of the imaging element 12 from the subject. In addition, a disk-like driving portion connection portion 111 is disposed at an end of the lens barrel 110 on the imaging element 12 side. The driving portion connection portion 111 is a portion to which a driving portion to be described later is connected.

The housing 120 is disposed to be adjacent to the substrate 11 and is disposed at a position surrounding the imaging element 12. The housing 120 in the drawing shows an example in which a top plate and a bottom plate are attached to a side plate 122 having a shape surrounding the imaging element 12. The top plate is disposed on the upper surface of the housing 120. The opening portion 121 is formed in the top plate, and the above-described lens barrel 110 passes therethrough. On the other hand, the bottom plate is disposed on the bottom surface of the housing 120. An opening portion 125 is formed in the bottom plate, and the imaging element 12 is disposed on the substrate 11 at a position adjacent to the opening portion 125. The bottom plate can be bonded to the substrate 11 using, for example, an adhesive. The top plate is disposed at a position closer to a subject in the housing 120, and the bottom plate is disposed at a position closer to the imaging element 12 in the housing 120. Here, a direction toward the subject in the optical axis of the optical system of the lens barrel 110 and a direction toward the imaging element 12 are assumed to be forward and rearward, respectively. The top plate and the bottom plate are respectively disposed at the front and rear of the housing 120.

A top plate portion in the vicinity of the opening portion 121 constitutes a front supporting portion 123 for supporting the lens barrel 110. The front driving portion 130 to be described later is connected to the front supporting portion 123. The front supporting portion 123 supports the lens barrel 110 through the front driving portion 130. On the other hand, the bottom plate portion in the vicinity of the opening portion 125 constitutes a rear supporting portion 124 for supporting the lens barrel 110. The rear driving portion 140 to be described later is connected to the rear supporting portion 124. The rear supporting portion 124 supports the lens barrel 110 through the rear driving portion 140. The front supporting portion 123 and the rear supporting portion 124 are respectively disposed at the front and the rear of the housing 120 and support the lens barrel 110.

The front driving portion 130 connects the lens barrel 110 and the front supporting portion 123 of the housing 120. In addition, the front driving portion 130 further performs the driving of the lens barrel 110. Specifically, the front driving portion 130 can displace and drive the lens barrel 110 by expanding and contracting by itself. The front driving portion 130 in the drawing is constituted by a plurality of driving elements 131 to 134. In the drawing, the driving elements 131 and 133 are shown. The driving element 131 and the like can be constituted by, for example, a piezoelectric element. The piezoelectric element is an element configured by sandwiching a piezoelectric material such as ceramic between two electrodes. The piezoelectric element can be contracted by applying a voltage between the two electrodes. In addition, it is also possible to use a piezoelectric element using a polymer elastomer instead of ceramic. In addition, the piezoelectric element can also be expanded by reversing the polarity of a voltage to be applied between the two electrodes depending on the type of piezoelectric material.

The rear driving portion 140 connects the lens barrel 110 and the rear supporting portion 124 of the housing 120. In addition, the rear driving portion 140 further performs the driving of the lens barrel 110. Similarly to the front driving portion 130, the rear driving portion 140 can drive the lens barrel 110 by expanding and contracting by itself. The rear driving portion 140 in the drawing is constituted by a plurality of driving elements 141 to 144. In the drawing, the driving elements 141 and 143 are shown. Similarly to the driving element 131 and the like, the driving element 141 and the like can be constituted by a piezoelectric element. Meanwhile, a wiring not shown in the drawing is connected to the driving element 131 and the like and the driving element 141 and the like, and a driving signal is transmitted through the wiring. A voltage based on the driving signal is applied to electrodes of the driving element 131 and the like.

The front driving portion 130 and the rear driving portion 140 are connected to the driving portion connection portion 111 of the lens barrel 110. The driving element 131 and the like constituting the front driving portion 130 are connected to a surface of the driving portion connection portion 111 on the front side. On the other hand, the driving element 141 and the like constituting the rear driving portion 140 are connected to a surface of the driving portion connection portion 111 on a rear side. In this manner, the lens barrel 110 is held by the housing 120 through the front driving portion 130 and the rear driving portion 140. The arrangement of the driving element 131 and the like and the arrangement of the driving element 141 and the like will be described in detail.

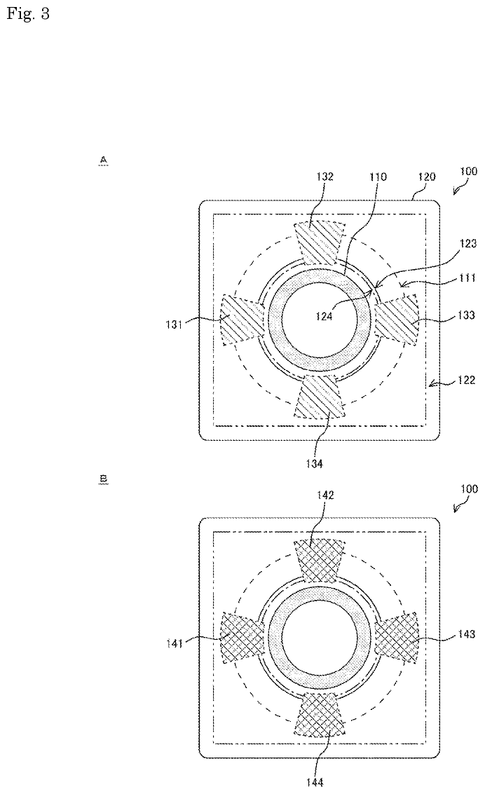

In the drawing, the lens barrel 110 can be displaced forward by contracting the front driving portion 130 (the driving elements 131 to 134 to be described later in FIG. 3), and the lens barrel 110 can be displaced backward by contracting the rear driving portion 140 (the driving elements 141 to 144 to be described later in FIG. 3). In addition, the lens barrel 110 can be displaced backward by expanding the front driving portion 130, and the lens barrel 110 can be displaced forward by expanding the rear driving portion 140. Thereby, a focal position of a subject can be adjusted.

Further, in a case where the front driving portion 130 is contracted and the rear driving portion 140 is expanded, a driving force to be applied to the lens barrel 110 can be substantially doubled. Similarly, when the front driving portion 130 is expanded, and the rear driving portion 140 is contracted, a driving force to be applied to the lens barrel 110 can also be improved. Thereby, the speed of displacement of the lens barrel 110 can be improved.

In addition, the driving element positioned diagonally to the lens barrel 110 is expanded and contracted, and thus the lens barrel 110 can be displaced in an inclination direction. Specifically, the lens barrel 110 can be inclined in the oblique right direction in the drawing by contracting the driving element 131 and the driving element 143. At this time, a driving force to be applied to the lens barrel 110 can be improved by expanding the driving element 133 and the driving element 141. In addition, the lens barrel 110 can be inclined in the oblique left direction in the drawing by contracting the driving element 133 and the driving element 141.

Note that the front driving portion 130 and the rear driving portion 140 in the drawing are disposed obliquely with respect to the optical axis of the optical system. Specifically, the driving elements 131 to 134 are disposed in an oblique direction from the front supporting portion 123 to the driving portion connection portion 111 and in a direction approaching the optical axis. Similarly, the driving elements 141 to 144 are disposed in an oblique direction from the rear supporting portion 124 to the driving portion connection portion 111 and in a direction approaching the optical axis. Thereby, the lens barrel 110 can be displaced in a direction perpendicular to the optical axis. Specifically, the lens barrel 110 can be displaced to the left in the drawing by contracting the driving element 131 and the driving element 141, and the lens barrel 110 can be displaced to the right in the drawing by contracting the driving element 133 and the driving element 143. In addition, the lens barrel 110 can be displaced to the right in the drawing by expanding the driving element 131 and the driving element 141, and the lens barrel 110 can be displaced to the left in the drawing by expanding the driving element 133 and the driving element 143.

Note that, when the lens barrel 110 is displaced to the left, a driving force can be improved by contracting the driving element 131 and the driving element 141 and expanding the driving element 133 and the driving element 143. Similarly, when the lens barrel 110 is displaced to the right, a driving force can be improved by expanding the driving element 131 and the driving element 141 and contracting the driving element 133 and the driving element 143. In this manner, the lens barrel 110 can be displaced in a direction perpendicular to the optical axis by obliquely disposing the front driving portion 130 and the rear driving portion 140.

In this manner, the lens barrel 110 is driven using the driving element 131 and the like, and thus it is possible to achieve miniaturization of and low-power consumption in the imaging device 10, as compared to a case where a mechanical component such as a motor is used.

Note that the configuration of the imaging device 10 is not limited to this example. For example, the driving portion connection portion 111 can also be disposed at a center portion on the side surface of the lens barrel 110. In addition, the front driving portion 130 and the rear driving portion 140 can also be directly connected to the side surface of the lens barrel 110 by omitting the driving portion connection portion 111. Even in such a case, the front driving portion 130 and the rear driving portion 140 are naturally disposed on the front and rear sides, respectively.

### [Arrangement of Driving Elements]

FIG. 3 is a diagram showing an example of the arrangement of the driving elements according to the first embodiment of the present disclosure. The drawing shows the optical unit 100 which is seen from the front, and shows an example of the arrangement of the driving elements 131 to 134 and the driving elements 141 to 144. In the drawing, a rectangle indicated by an alternating two dots-dashed line represents an end of the side plate 122 of the housing 120. A circle indicated by a solid line represents the opening portion 121 of the top plate of the housing 120 and represents an end of the front supporting portion 123. A circle indicated by an alternating dotted-dashed line represents the opening portion 125 of the bottom plate of the housing 120 and represents an end of the rear supporting portion 124. A circle indicated by a dashed line represents the driving portion connection portion 111 of the lens barrel 110.

A in the drawing is a diagram showing the arrangement of the driving elements 131 to 134. In A of the drawing, a region surrounded by a broken line indicates each of the driving elements 131 to 134. As shown in A of the drawing, the driving elements 131 to 134 are disposed at intervals of 90 degrees on a circumference along the front supporting portion 123 and the driving portion connection portion 111.

B in the drawing is a diagram showing the arrangement of the driving elements 141 to 144. In B of the drawing, a region surrounded by a broken line indicates each of the driving elements 141 to 144. As shown in B of the drawing, the driving elements 141 to 144 are disposed at intervals of 90 degrees on a circumference along the rear supporting portion 124 and the driving portion connection portion 111 at positions overlapping the driving elements 131 to 134. In this manner, the driving elements 141 to 144 are disposed at positions facing the driving element 131 to 144 with the driving portion connection portion 111 interposed therebetween.

In the drawing, the direction of the optical axis is assumed to be a z-axis. The lens barrel 110 can be displaced forward along the z-axis by contracting the driving elements 131 to 134 and expanding the driving elements 141 to 134 as described above. In addition, the lens barrel 110 can be displaced backward along the z-axis by expanding the driving elements 131 to 134 and contracting the driving elements 141 to 134 as described above.

In addition, the horizontal direction of the paper in the drawing is assumed to be an x-axis, and toward the right side and the left side in the drawing are assumed to be positive and negative directions, respectively. In addition, the vertical direction of the paper in the drawing is assumed to be a y-axis, and toward the upper side and the lower side in the drawing are assumed to be positive and negative directions, respectively. The lens barrel 110 can be displaced in the positive direction of the x-axis by expanding the driving element 131 and the driving element 141 and contracting the driving element 133 and the driving element 143 as described above. In addition, the lens barrel 110 can be displaced in the negative direction of the x-axis, for example, by contracting the driving element 131 and the driving element 141 and expanding the driving element 133 and the driving element 143.

In addition, the lens barrel 110 can be displaced in the positive direction of the y-axis, for example, by contracting the driving element 132 and the driving element 142 and expanding the driving element 134 and the driving element 144. In addition, the lens barrel 110 can be displaced in the negative direction of the y-axis, for example, by expanding the driving element 132 and the driving element 142 and contracting the driving element 134 and the driving element 144.

In addition, the lens barrel 110 can be inclined in the positive direction of the x-axis by expanding the driving element 131 and the driving element 143 and contracting the driving element 133 and the driving element 141 as described above. In addition, the lens barrel 110 can be inclined in the negative direction of the x-axis by contracting the driving element 131 and the driving element 143 and expanding the driving element 133 and the driving element 141 as described above. Thereby, the lens barrel 110 can be displaced in a rotation direction (3 direction) along the y-axis.

In addition, the lens barrel 110 can be inclined in the positive direction of the y-axis, for example, by contracting the driving element 132 and the driving element 144 and expanding the driving element 134 and the driving element 142. In addition, the lens barrel 110 can be inclined in the negative direction of the y-axis, for example, by expanding the driving element 132 and the driving element 144 and contracting the driving element 134 and the driving element 142. Thereby, the lens barrel 110 can be displaced in a rotation direction (a direction) along the x-axis.

In addition, the lens barrel 110 can be displaced in the upper right direction in the drawing by contracting the driving element 132 and 133 and the driving element 142 and 143 and expanding the driving element 134 and 131 and the driving element 144 and 141. In addition, the displacement of the driving elements 131 to 134 and the driving elements 141 to 144 can be adjusted by adjusting a voltage to be applied. In this manner, the optical unit 100 in the drawing can displace the lens barrel 110 in any direction except for rotation along the z-axis.

The driving of the lens barrel 110 by the front driving portion 130 and the rear driving portion 140 can be performed when the adjustment of a focal position of a subject during imaging and camera shake correction are performed. In addition, tilt imaging and the like can be performed by driving the lens barrel 110. In addition, the tilt imaging and the like can also be performed when an optical axis is adjusted in the manufacturing process for the imaging device 10.

### Modification Example

The optical unit 100 described above includes the driving elements 131 to 134 and the driving elements 141 to 144, but the arrangement of the driving elements can also be changed.

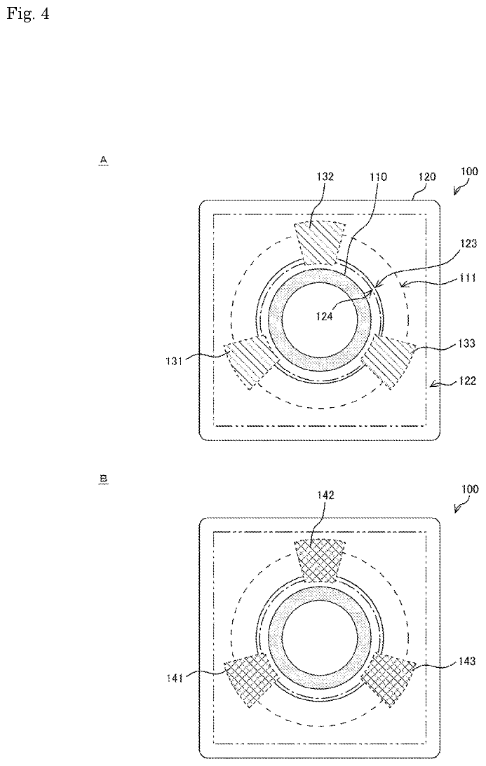

FIG. 4 is a diagram showing an example of the arrangement of driving elements according to a modification example of the first embodiment of the present disclosure. Similarly to FIG. 3, FIG. 4 is a diagram showing an optical unit 100 which is seen from the front. The optical unit 100 is different from the optical unit 100 in FIG. 3 in that the driving element 134 and the driving element 144 are omitted.

In A of the drawing, driving elements 131 to 133 are disposed at intervals of 120 degrees on a circumference along the front supporting portion 123 and the driving portion connection portion 111. Further, in B of the drawing, driving elements 141 to 143 can be disposed at intervals of 120 degrees on a circumference along the rear supporting portion 124 and the driving portion connection portion 111 at positions overlapping the driving elements 131 to 133.

As described above, the imaging device 10 according to the first embodiment of the present disclosure connects the lens barrel 110 to the housing 120 by the front driving portion 130 and the rear driving portion 140 and drives the lens barrel 110. It is possible to drive and displace the lens barrel 110 from both the front and the rear and improve a driving force. A driving speed can be improved.

### 2. Second Embodiment

In the imaging device 10 according to the above-described first embodiment, the driving element 131 and the like constituting the front driving portion 130 and the driving element 141 and the like constituting the rear driving portion 140 are disposed at positions overlapping each other when seen in a top view. On the other hand, an imaging device 10 according to the second embodiment of the present disclosure is different from that in the above-described first embodiment in that driving elements constituting a front driving portion 130 and a rear driving portion 140 are disposed at positions shifted from each other when seen in a top view.

### [Arrangement of Driving Elements]

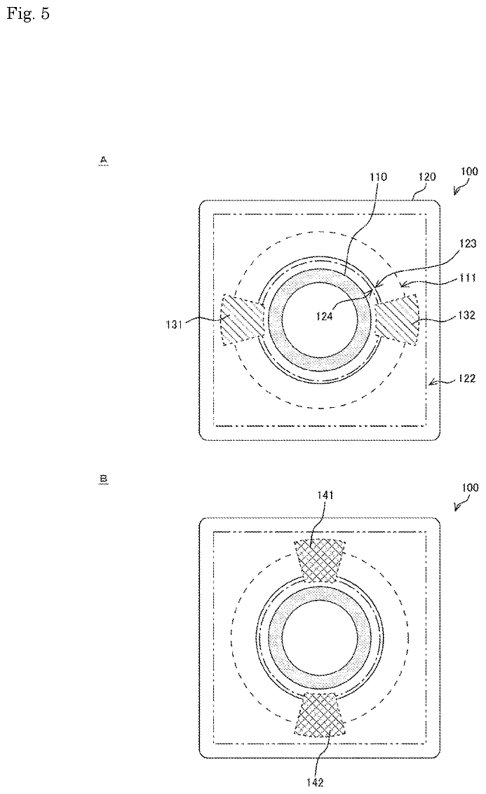

FIG. 5 is a diagram showing an example of the arrangement of driving elements according to the second embodiment of the present disclosure. Similarly to FIG. 3, FIG. 5 is a diagram showing an optical unit 100 which is seen from the front and is a diagram showing an example of the arrangement of driving elements 131 and the like, and a driving element 141 and the like. The optical unit 100 is different from the optical unit 100 described in FIG. 3 in that driving elements 133 and 134 and driving elements 143 and 144 are omitted, and the driving element 131 and the like, and the driving element 141 and the like are disposed at positions shifted from each other.

In A of the drawing, the driving elements 131 and 132 are disposed at positions facing each other with a lens barrel 110 interposed therebetween. That is, the driving elements 131 and 132 are disposed at intervals of 180 degrees on a circumference along a front supporting portion 123 and a driving portion connection portion 111.

In B of the drawing, the driving elements 141 and 142 are disposed at positions facing each other with the lens barrel 110 interposed therebetween, similar to the driving elements 131 and 132. The driving elements 141 and 142 are disposed at intervals of 180 degrees on a circumference along a rear supporting portion 124 and a driving portion connection portion 111 at positions shifted from the driving elements 131 and 132 by 90 degrees. That is, the driving elements 141 and 142 are disposed at positions shifted from the driving elements 131 and 132 in a circumferential direction of the lens barrel 110. In this manner, the lens barrel 110 are supported at four points, that is, the driving elements 131 and 132 and the driving elements 141 and 142. Thereby, the position and inclination of the lens barrel 110 can be stabilized.

The lens barrel 110 can be displaced to the front along the z-axis, for example, by contracting the driving elements 131 and 132 and expanding the driving elements 141 and 142. In addition, the lens barrel 110 can be displaced to the rear along the z-axis, for example, by expanding the driving elements 131 and 132 and contracting the driving elements 141 and 142.

In addition, the lens barrel 110 can be rotated in an a direction by expanding and contracting any one of the driving elements 131 and 132. In addition, the lens barrel 110 can be rotated in a 8 direction by expanding and contracting any one of the driving elements 141 and 142.

### Modification Example

The above-described optical unit 100 includes the driving elements 131 and 132 and the driving elements 141 and 142, but the number of driving elements can also be increased.

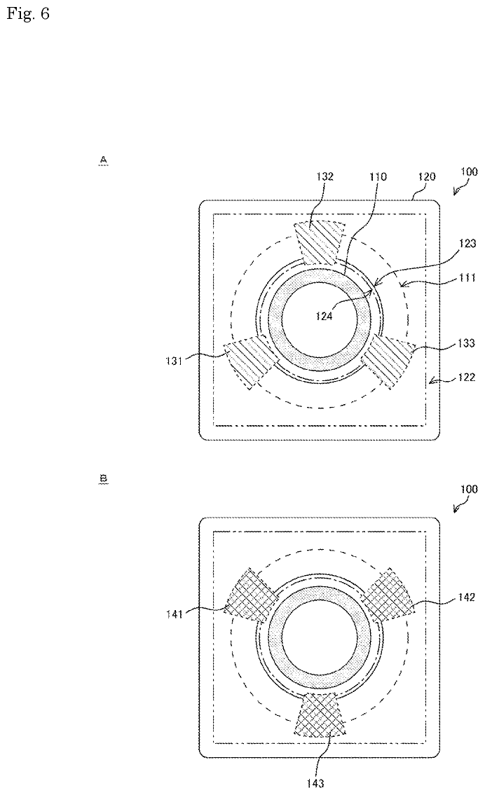

FIG. 6 is a diagram showing an example of the arrangement of driving elements according to a modification example of the second embodiment of the present disclosure. Similarly to FIG. 5, FIG. 6 is a diagram showing the optical unit 100 which is seen from the front. The optical unit 100 is different from the optical unit 100 in FIG. 5 in that the driving element 133 and the driving element 143 are added.

In A of the drawing, the driving elements 131 to 133 are disposed at intervals of 120 degrees on a circumference along the front supporting portion 123 and the driving portion connection portion 111. Further, in B of the drawing, the driving elements 141 to 143 are disposed at intervals of 120 degrees on a circumference along the rear supporting portion 124 and the driving portion connection portion 111 at positions shifted from the driving elements 131 to 133 by 60 degrees.

A displacement range of the lens barrel 110 can be widened by increasing the number of driving elements to be disposed. For example, the lens barrel 110 can be displaced in the upper right direction in the drawing by contracting the driving elements 132 and 133 and the driving element 142 and expanding the driving elements 131 and the driving elements 143 and 141.

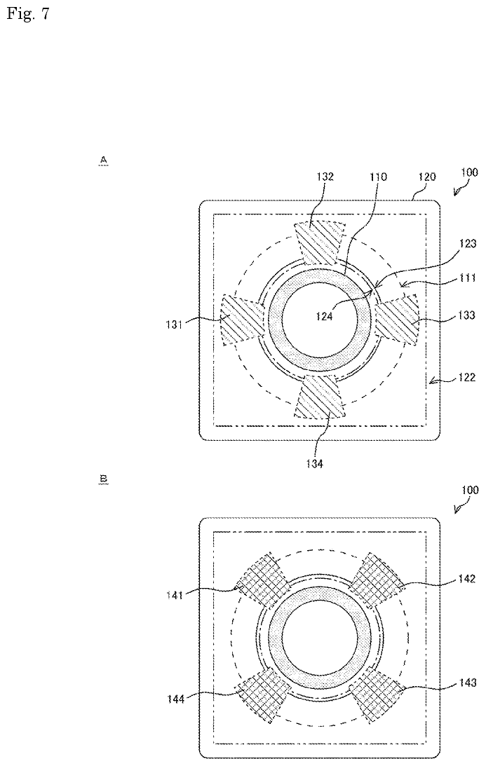

FIG. 7 is a diagram showing another example of the arrangement of driving elements according to a modification example of the second embodiment of the present disclosure. The optical unit 100 is different from the optical unit 100 in FIG. 5 in that the driving elements 133 and 134 and the driving elements 143 and 144 are added.

In A of the drawing, the driving elements 131 to 134 are disposed at intervals of 90 degrees on a circumference along the front supporting portion 123 and the driving portion connection portion 111. Further, in B of the drawing, the driving elements 141 to 144 are disposed at intervals of 90 degrees on a circumference along the rear supporting portion 124 and the driving portion connection portion 111 at positions shifted from the driving elements 131 to 134 by 45 degrees.

The number of driving elements to be disposed is further increased, and thus it is possible to finely adjust the displacement of the lens barrel 110.

The other configurations of the imaging device 10 are similar to the configurations of the imaging device 10 described in the first embodiment of the present disclosure, and thus description thereof will be omitted.

As described above, in the imaging device 10 according to the second embodiment of the present disclosure, the number of driving elements constituting the front driving portion 130 can be reduced, and the configuration of the imaging device 10 can be simplified.

### 3. Third Embodiment

In the imaging device 10 according to the above-described first embodiment, the front driving portion 130 and the rear driving portion 140 are disposed obliquely with respect to the optical axis of the optical system. On the other hand, an imaging device 10 according to a third embodiment of the present disclosure is different from that in the above-described first embodiment in that a front driving portion 130 and a rear driving portion 140 are disposed in parallel with an optical axis.

### [Configuration of Cross-Section of Imaging Device]

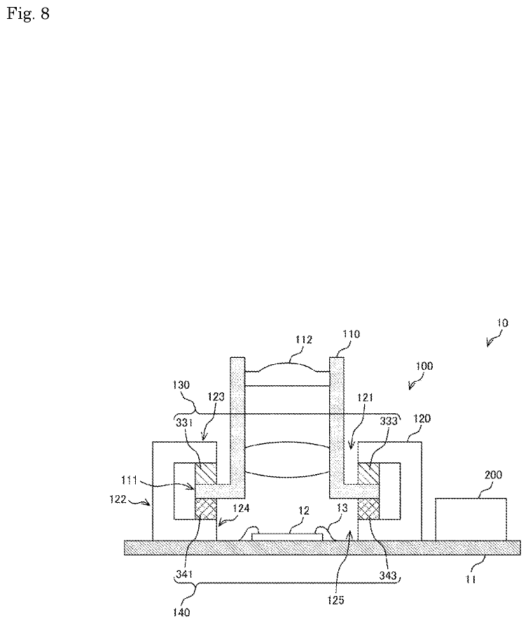

FIG. 8 is a cross-sectional view showing a configuration example of the imaging device according to the third embodiment of the present disclosure. Similarly to FIG. 2, FIG. 8 shows a configuration example of the imaging device 10. The imaging device 10 is different from the imaging device 10 described in FIG. 2 in that the front driving portion 130 and the rear driving portion 140 are disposed in a direction parallel to a lens barrel 110.

The front driving portion 130 in the drawing is constituted by driving elements 331 to 334 (driving elements 332 and 334 are not shown in the drawing). The driving elements 331 to 334 are disposed in a direction parallel to the lens barrel 110 between a front supporting portion 123 and a driving portion connection portion 111 and connect the front supporting portion 123 and the lens barrel 110 to each other. In addition, the rear driving portion 140 in the drawing is constituted by driving elements 341 to 344 (driving elements 342 and 344 are not shown in the drawing). The driving elements 341 to 344 are disposed in a direction parallel to the lens barrel 110 between the rear supporting portion 124 and the driving portion connection portion 111 and connect the rear supporting portion 124 and the lens barrel 110 to each other. It is possible to displace the lens barrel 110 in a z-axis direction and to rotate the lens barrel 110 in a and 8 directions by the front driving portion 130 and the rear driving portion 140.

In this manner, the front driving portion 130 and the rear driving portion 140 in the drawing are disposed in a direction parallel to an optical axis of an optical system of the lens barrel 110 and drive the lens barrel 110. It is not necessary to dispose driving elements constituting the front driving portion 130 and the like in an oblique direction, and thus a manufacturing process for the optical unit 100 can be simplified.

The other configurations of the imaging device 10 are similar to the configurations of the imaging device 10 described in the first embodiment of the present disclosure, and thus description thereof will be omitted.

As described above, in the imaging device 10 according to the third embodiment of the present disclosure, the front driving portion 130 and the rear driving portion 140 are disposed in a direction parallel to the optical axis of the lens barrel 110. Thereby, it is possible to simplify a manufacturing process for the optical unit 100 of the imaging device 10.

### 4. Fourth Embodiment

The imaging device 10 according to the above-described first embodiment performs the displacement of the lens barrel 110 in the x, y, z, α, and β directions. On the other hand, an imaging device 10 according to a fourth embodiment of the present disclosure is different from that in the above-described first embodiment in that the displacement of the lens barrel 110 in a θ direction is further performed.

### [Arrangement of Driving Elements]

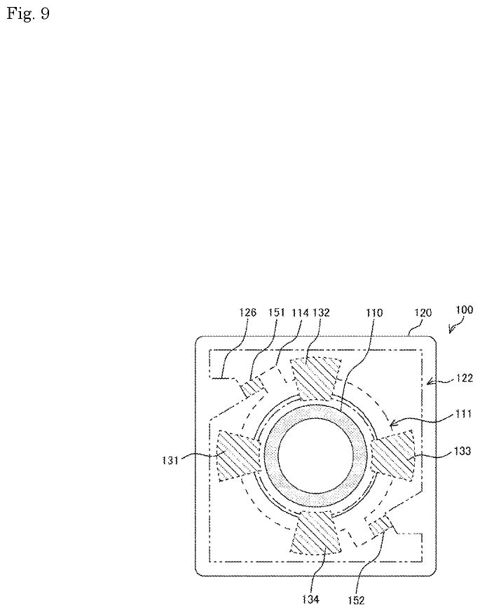

FIG. 9 is a diagram showing an example of the arrangement of driving elements according to the fourth embodiment of the present disclosure. Similarly to FIG. 3, FIG. 9 is a diagram showing an optical unit 100 which is seen from the front and is a diagram showing an example of the arrangement of a driving element 131 and the like, and a driving element 141 and the like. The optical unit 100 is different from the optical unit 100 described in FIG. 3 in that protrusion portions 126 and 114 are respectively disposed in a housing 120 and a driving portion connection portion 111, and driving elements 151 and 152 are further disposed.

In the housing 120 in the drawing, two protrusion portions 126 are disposed in a side plate 122. The protrusion portions 126 are disposed at positions symmetrical to the optical axis of the side plate 122. Further, in the driving portion connection portion 111 in the drawing, two protrusion portions 114 are disposed. The protrusion portions 114 are disposed at positions symmetrical to the optical axis of the driving portion connection portion 111.

The driving elements 151 and 152 are disposed between the protrusion portion 126 of the side plate 122 and the protrusion portion 114 of the driving portion connection portion 111, and displace the lens barrel 110 in a rotation direction (0 direction) with respect to the optical axis. The driving elements 151 and 152 are disposed such that the direction of expansion and contraction is parallel to the tangent line of the outer circumference of the driving portion connection portion 111. In addition, the driving elements 151 and 152 are disposed at positions symmetrical to the optical axis and drive the lens barrel 110 in a rotation direction. In the drawing, the lens barrel 110 can be displaced counterclockwise by contracting the driving elements 151 and 152, and the lens barrel 110 can be displaced clockwise by expanding the driving elements 151 and 152. It is possible to perform 6-axis displacement of the lens barrel 110 in the x, y, z, α, β and θ directions by adding the driving elements 151 and 152.

Note that the configuration of the imaging device 10 is not limited to this example. For example, it is also possible to adopt a configuration in which three or less driving elements 131 and the like, and three or less driving elements 141 and the like are disposed.

The other configurations of the imaging device 10 are similar to the configurations of the imaging device 10 described in the first embodiment of the present disclosure, and thus description thereof will be omitted.

As described above, the imaging device 10 according to the fourth embodiment of the present disclosure can further perform the displacement of the lens barrel 110 in the θ direction by disposing the driving elements 151 and 152 such that the direction of expansion and contraction is parallel to the tangent line of the outer circumference of the driving portion connection portion 111.

### 5. Fifth Embodiment

The imaging device 10 according to the above-described second embodiment includes the driving elements 131 to 134 and the driving elements 141 to 144. On the other hand, an imaging device 10 according to a fifth embodiment of the present disclosure is different from that in the above-described second embodiment in that the imaging device 10 includes a driving element that shields incident light.

### [Arrangement of Driving Elements]

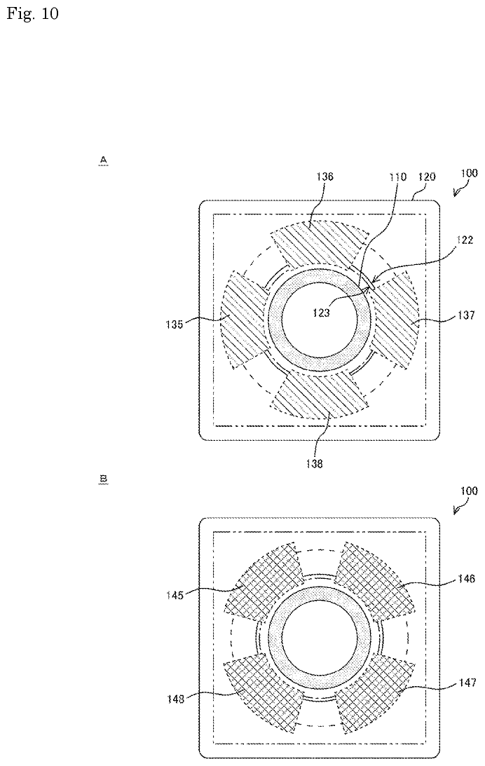

FIG. 10 is a diagram showing an example of the arrangement of driving elements according to the fifth embodiment of the present disclosure. Similarly to FIG. 7, FIG. 10 is a diagram showing the optical unit 100 which is seen from the front and is a diagram showing an example of the arrangement of driving elements. The optical unit 100 is different from the optical unit 100 described in FIG. 7 in that driving elements 135 to 138 and driving elements 145 to 148 are disposed instead of the driving elements 131 to 134 and the driving elements 141 to 144.

The driving elements 135 to 138 constitute a front driving portion 130. The driving elements 135 to 138 drive the lens barrel 110 and shield incident light. In addition, the driving elements 145 to 148 constitute a rear driving portion 140 and are disposed at positions shifted from the driving elements 135 to 138. The driving elements 145 to 148 drive the lens barrel 110 and shield incident light. The driving elements 135 to 138 and the driving elements 145 to 148 are disposed to shield light, and thus light incident into the optical unit 100 through a gap between a housing 120 and the lens barrel 110 in an opening portion 121 can be reduced. For example, a piezoelectric element using a polymer elastomer in which a light-shielding material is dispersed can be used for the driving elements 135 to 138 and the driving elements 145 to 148. In addition, as shown in the drawing, a light-shielding ability can be improved by using the driving elements 135 to 138 and the driving elements 145 to 148 configured to have a wider area than the driving element 131 and the like shown in FIG. 7.

Note that the configuration of the imaging device 10 is not limited to this example. Fr example, the sizes of the driving elements 135 to 138 and the like can also be changed so that the driving elements have shapes in contact with adjacent driving elements. In addition, any one of the driving elements 135 to 138 and the driving elements 145 to 148 can also be replaced with a driving element that does not have a light-shielding ability.

The other configurations of the imaging device 10 are similar to the configurations of the imaging device 10 described in the second embodiment of the present disclosure, and thus description thereof will be omitted.

As described above, in the imaging device 10 according to the fifth embodiment of the present disclosure, the driving elements 135 to 138 and the driving elements 145 to 148 are disposed to shield incident light. Thereby, it is possible to prevent the leakage of incident light to an imaging element 12 and to prevent the deterioration of an image quality.

Note that the driving elements 151 and 152 according to the fourth embodiment may be combined with the optical units 100 according to the first to third embodiments. In addition, similarly to the driving elements 135 to 138 and the driving elements 145 to 148 according to the fifth embodiment, a driving element that shields incident light may be applied as the driving elements of the optical units 100 according to the first to third embodiments.

### Sixth Embodiment

The technique according to the present disclosure (the present technique) can be applied to various products. For example, the present technique may be realized as an imaging device mounted on a camera and the like.

### [Configuration of Camera]

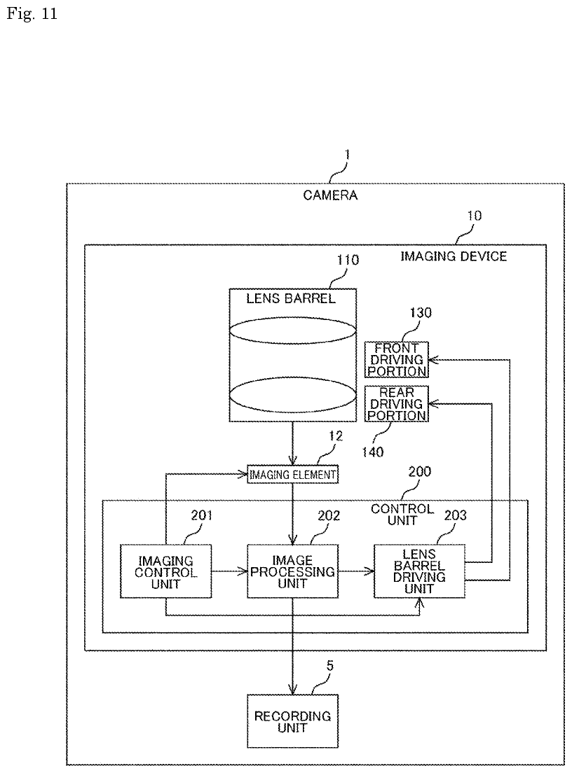

FIG. 11 is a block diagram showing a schematic configuration example of a camera which is an example of a device to which the present technique is applicable. A camera 1 in the drawing includes an imaging device 10 and a recording unit 5. In the imaging device 10 in the drawing, a housing 120 is not shown.

The recording unit 5 is a unit in which images generated by the imaging device 10 are recorded. A storage device such as a semiconductor memory or a hard disk can be used as the recording unit 5.

A control unit 200 in the drawing includes an imaging control unit 201, an image processing unit 202, and a lens barrel driving unit 203.

The imaging control unit 201 is a unit that controls imaging in the imaging device 10. The imaging control unit 201 controls imaging by outputting a control signal to the imaging element 12 and the image processing unit 202. For example, a control signal for causing the imaging element 12 to start imaging can be generated and output on the basis of a signal received from an input device (not shown) such as a push button switch. The imaging element 12 to which the control signal is input generates and outputs an image signal after a predetermined exposure period has elapsed. In addition, the imaging control unit 201 can output a control signal to a lens barrel driving unit 203 to be described later and can control the lens barrel driving unit 203. For example, the imaging control unit 201 can generate a control signal for displacing the lens barrel 110 to the front or the rear with respect to an optical axis and can output the generated control signal to the lens barrel driving unit 203 during imaging, and can adjust a focal position of a subject.

The lens barrel driving unit 203 is a unit that drives the lens barrel 110. The lens barrel driving unit 203 drives the lens barrel 110 by generating and outputting driving signals of the driving elements constituting the front driving portion 130 and the rear driving portion 140. In addition, the lens barrel driving unit 203 holds correction values of driving signals of a driving element 131 and the like and a driving element 141 and the like constituting the front driving portion 130 and the rear driving portion 140. The correction value is an initial value of a control signal for displacing the lens barrel 110 in order to adjust the optical axis of the lens barrel 110. For example, a correction value is output to be superimposed on a driving signal when the lens barrel 110 is displaced to the front and the rear in order to adjust a focal position of a subject. Thereby, it is possible to adjust the focal position while holding a state where the optical axis of the lens barrel 110 has been adjusted.

The image processing unit 202 processes an image signal generated by the imaging element 12. The image processing unit 202 processes an image signal on the basis of a control signal received from the imaging control unit 201. The processing of the image signal corresponds to, for example, processing for generating an image from the image signal. In addition, the generated image is output to the recording unit 5 described above. In addition, the image processing unit 202 can also perform processing for evaluating a generated image. The evaluation is processing for determining whether or not an optical axis is required to be adjusted by detecting a defect or the like of an image. For example, the image processing unit 202 can determine that an optical axis is required to be adjusted in a case where blurring or the like has been detected in a peripheral portion of an image. At this time, the image processing unit 202 calculates a correction value of the position of the lens barrel 110 and outputs the correction value to the lens barrel driving unit 203. The correction value held in the lens barrel driving unit 203 described above is updated by the output correction value. The optical axis can be adjusted by such processing.

In a manufacturing process for the imaging device 10, the optical axis of the lens barrel 110 can be adjusted. As the adjustment, for example, the adjustment of the lens barrel 110 in the x-axis, y-axis, and z-axis and the adjustment of a rotation angle in the α and β directions can be performed. In addition, the adjustment of the optical axis can be performed by displacing the lens barrel 110 on the basis of a known method such as active alignment. A driving signal corresponding to the displacement of the lens barrel 110 based on adjustment corresponds to an initial value of the above-described correction value.

In addition, it is also possible to adjust an optical axis after the use of the imaging device 10 is started. For example, in a case where the optical axis deviates due to a change in the shape of the housing 120 due to external factors, the optical axis can be adjusted in a state where the imaging device is mounted on a product.

### [Adjustment of Optical Axis]

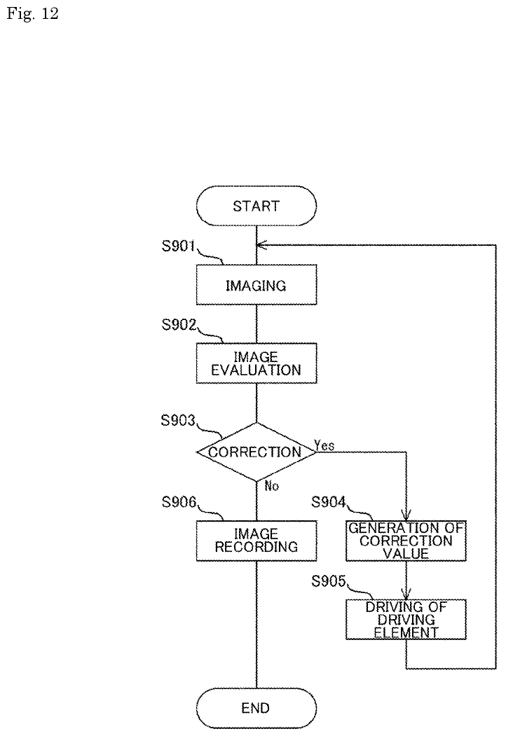

FIG. 12 is a diagram showing an example of a method of adjusting an optical axis according to an embodiment of the present disclosure. The drawing is a diagram showing an example of a method of adjusting an optical axis in the imaging device 10. Processing in the drawing is performed on the assumption that an optical axis is adjusted when imaging is performed in the imaging device 10.

First, the imaging element 12 performs the imaging of a subject. An image signal generated by the imaging is transmitted to the image processing unit 202. This is performed on the basis of a control signal received from the imaging control unit 201 (step S901). Next, the image processing unit 202 forms an image on the basis of the transmitted image signal and evaluates whether or not correction is required (step S902). As a result of the evaluation, in a case where correction is required (step S903: Yes), the image processing unit 202 generates a correction value (step S904). The generated correction value is output to the lens barrel driving unit 203. Next, the lens barrel driving unit 203 holds the output correction value, generates a driving signal based on the correction value, and outputs the driving signal to the front driving portion 130 and the rear driving portion 140 (step S905). Thereafter, the processing proceeds to the process of step S901.

On the other hand, as a result of the evaluation, in a case where it is determined in step S903 that correction is not required (step S903: No), the image processing unit 202 outputs an image to the recording unit 5 to record the image in the recording unit 5 (step S906). By the above-described procedure, it is possible to perform imaging and processing for adjusting an optical axis.

Finally, the description of each of the above-described embodiments is an example of the present disclosure, and the present disclosure is not limited to the above-described embodiments. Therefore, it goes without saying that various changes can be made according to the design and the like within the scope without departing from the technical idea according to the present disclosure even in other than this embodiment.

Additionally, the effects described in the present specification are merely exemplary and not limited. Further, other effects may be obtained.

The drawings in the above-described embodiment are schematic, and the dimensional ratios and the like of each part do not always match the actual ones. In addition, it is needless to say that drawings include portions where dimensional relationships and ratios differ between the drawings.

In addition, the processing procedures in the above-described embodiments may be ascertained as methods including the series of procedures or may be ascertained as a program that causes a computer to perform the series of procedures or a recording medium that stores the program. As the recording medium, for example, a compact disc (CD), a digital versatile disc (DVD), a memory card, or the like can be used.

Further, the present technique can have the following configurations.

(1) An optical unit including:
a lens barrel that includes an imaging optical system;
a housing that includes a front supporting portion and a rear supporting portion in order to support the lens barrel, the front supporting portion being disposed at a front in a direction toward a subject along an optical axis of the imaging optical system, and the rear supporting portion being disposed at a rear with an orientation opposite to being at the front;
a front driving portion that connects the lens barrel and the front supporting portion and drives the lens barrel; and a rear driving portion that connects the lens barrel and the rear supporting portion and drives the lens barrel.
(2) The optical unit according to (1), wherein the front driving portion and the rear driving portion are driven by displacing the lens barrel.
(3) The optical unit according to (2), wherein a driving element that displaces the lens barrel is disposed in the front driving portion and the rear driving portion.
(4) The optical unit according to (3), wherein the driving element is constituted by a piezoelectric element.
(5) The optical unit according to (3), wherein a plurality of the driving elements are disposed in the front driving portion and the rear driving portion.
(6) The optical unit according to (5), wherein the rear driving portion is configured such that the plurality of driving elements are disposed at positions facing the plurality of driving elements of the front driving portion.
(7) The optical unit according to (5), wherein the rear driving portion is configured such that the plurality of driving elements are disposed at positions shifted from the plurality of driving elements of the front driving portion.
(8) The optical unit according to any one of (1) to (7), wherein the front driving portion and the rear driving portion are disposed obliquely with respect to the optical axis.
(9) The optical unit according to any one of (1) to (8), wherein the lens barrel includes a driving portion connection portion to which the front driving portion and the rear driving portion are connected.
(10) The optical unit according to any one of (1) to (9), wherein at least one of the front driving portion and the rear driving portion further shields incident light.
(11) An imaging device including:
an imaging element;
a lens barrel that includes an imaging optical system that forms an image of a subject on the imaging element;
a housing that includes a front supporting portion and a rear supporting portion in order to support the lens barrel, the front supporting portion being disposed at a front in a direction toward a subject along an optical axis of the imaging optical system, and the rear supporting portion being disposed at a rear with an orientation opposite to being at the front;
a front driving portion that connects the lens barrel and the front supporting portion and drives the lens barrel; and a rear driving portion that connects the lens barrel and the rear supporting portion and drives the lens barrel.

### REFERENCE SIGNS LIST

1 Camera
10 Imaging device
12 Imaging element
100 Optical unit
110 Lens barrel
111 Driving portion connection portion
120 Housing
123 Front supporting portion
124 Rear supporting portion
130 Front driving portion
131 to 138, 141 to 148, 151, 152, 331 to 334, 341 to 344 Driving element
140 Rear driving portion
200 Control unit
201 Imaging control unit
202 Image processing unit
203 Lens barrel driving unit

What is claimed is:

1. An optical unit, comprising:
a lens barrel that includes an imaging optical system;
a housing that includes a front supporting portion and a rear supporting portion in order to support the lens barrel, the front supporting portion being disposed at a front in a direction toward a subject along an optical axis of the imaging optical system, and the rear supporting portion being disposed at a rear with an orientation opposite to being at the front;
a front driving portion that connects the lens barrel and the front supporting portion and drives the lens barrel; and
a rear driving portion that connects the lens barrel and the rear supporting portion and drives the lens barrel.

2. The optical unit according to claim 1, wherein the front driving portion and the rear driving portion are driven by displacing the lens barrel.

3. The optical unit according to claim 2, wherein a driving element that displaces the lens barrel is disposed in the front driving portion and the rear driving portion.

4. The optical unit according to claim 3, wherein the driving element is constituted by a piezoelectric element.

5. The optical unit according to claim 3, wherein a plurality of the driving elements are disposed in the front driving portion and the rear driving portion.

6. The optical unit according to claim 5, wherein the rear driving portion is configured such that the plurality of driving elements are disposed at positions facing the plurality of driving elements of the front driving portion.

7. The optical unit according to claim 5, wherein the rear driving portion is configured such that the plurality of driving elements are disposed at positions shifted from the plurality of driving elements of the front driving portion.

8. The optical unit according to claim 1, wherein the front driving portion and the rear driving portion are disposed obliquely with respect to the optical axis.

9. The optical unit according to claim 1, wherein the lens barrel includes a driving portion connection portion to which the front driving portion and the rear driving portion are connected.

10. The optical unit according to claim 1, wherein at least one of the front driving portion and the rear driving portion further shields incident light.

11. An imaging device, comprising:
an imaging element;
a lens barrel that includes an imaging optical system that forms an image of a subject on the imaging element;
a housing that includes a front supporting portion and a rear supporting portion in order to support the lens barrel, the front supporting portion being disposed at a front in a direction toward a subject along an optical axis of the imaging optical system, and the rear supporting portion being disposed at a rear with an orientation opposite to being at the front;
a front driving portion that connects the lens barrel and the front supporting portion and drives the lens barrel; and
a rear driving portion that connects the lens barrel and the rear supporting portion and drives the lens barrel.
